(19) United States
(12) Patent Application Publication
(10) Pub. No.: US 2024/0392171 A1
(43) Pub. Date: Nov. 28, 2024

(54) WATER-BASED ADHESIVE APPLIED TO WOOD AND BAMBOO

(71) Applicant: Alliance Materials Technology Co., Ltd., Taoyuan City (TW)

(72) Inventors: Chen-Lung Lin, Taoyuan City (TW); Henn-Sheng Hsia, Taoyuan City (TW); Yu-Hao Chang, Taoyuan City (TW); Chiang-Yun Li, Taoyuan City (TW); Jia-Yi Chen, Taoyuan City (TW)

(21) Appl. No.: 18/410,079

(22) Filed: Jan. 11, 2024

(30) Foreign Application Priority Data
May 23, 2023 (TW) 112119137

(51) Int. Cl. C09J 107/02; C08K 3/013; C09J 11/04; C09J 11/06; C09J 11/08; C09J 125/10; C09J 129/04

(52) U.S. Cl. CPC C09J 107/02; C08K 3/013; C09J 11/04; C09J 11/06; C09J 11/08; C09J 125/10; C09J 129/04; C09J 2400/10; C09J 2400/303; C09J 2407/00; C09J 2409/00; C09J 2425/00; C09J 2429/00

(57) ABSTRACT

A water-based adhesive applied to wood and bamboo includes a main agent composed of water-soluble polymer, synthetic rubber latex and natural latex and a curing agent selected from isocyanate or quaternary ammonium salt polymer. Wherein, the weight ratio of the main agent to the curing agent is between 200:1 and 1:1; the water-soluble polymer is polyvinyl alcohol and is about 2-30 weight percent of the total solids of the main agent; the synthetic rubber latex is about 2-60 weight percent of the total solids of the main agent; and the natural latex is about 5-90 weight percent of the total solids of the main agent. The present invention provides a formaldehyde-free adhesive and introduces natural and renewable raw materials to reduce dependence on petrochemical products and improve the sustainability of related industries.

### FIELD OF THE INVENTION

The present invention relates to an adhesive, particularly relates to a water-based adhesive applied to wood and bamboo.

### BACKGROUND OF THE INVENTION

Traditionally, the adhesives applied to wood and bamboo are mostly petrochemical products, such as phenol, urea, melamine, and formaldehyde. Adhesives made of these petrochemical raw materials, or their derivatives can often provide good adhesion, mechanical strength, temperature resistance and water resistance, and their low cost and affordable price make them difficult to be replaced. However, with the rising awareness of environmental protection and the emphasis on human health, the shortcomings of adhesives made of petrochemical raw materials have gradually been pointed out.

Owing to the good reactivity of formaldehyde, the urea formaldehyde resin adhesive containing formaldehyde usually has the advantages of high adhesion, good temperature resistance and good water resistance. Currently, more than 80% of the adhesives applied to wood and bamboo still use urea-formaldehyde glue, but formaldehyde has been proven to be a toxic substance that may cause cancer to the human body. Moreover, wood and bamboo made of formaldehyde-containing adhesives are used in various furniture, interior building materials, interior decoration, etc., and the emission cycle of formaldehyde can be as long as 10 to 15 years.

Countries around the world are increasingly implementing stringent regulations on the carcinogenic risk associated with formaldehyde content. The development of a new type of bio-based formaldehyde-free adhesive that can enhance ecological sustainability and reduce human health hazards has become a clear objective.

The bio-based formaldehyde-free adhesives, in addition to not using formaldehyde, also incorporate bio-based materials. In recent years, bio-based materials such as soy protein, lignin, starch, and tannins have been commonly applied in wood adhesives. However, they have not been widely used in commercial applications due to their weak bonding strength and poor water resistance. Among them, soy protein has been used in wood bonding since the 1930s, but its poor bonding strength has always been a criticized drawback. Improvement in this aspect is disclosed in US Patent Publication No. U.S. Pat. No. 9,493,693, but actual commercial application still faces challenges such as high heating temperatures, long processing times, and energy consumption. Moreover, soy protein presents difficulties in practical processing, making it challenging for operators to adapt.

Furthermore, although lignin and tannins have good structural stability, they also exhibit low reactivity, often requiring chemical modification to enhance their reactivity. Lignin, containing phenolic functional groups, is commonly added to phenol-formaldehyde resins. However, it suffers from poor reactivity, high reaction temperatures, and inadequate water resistance. Starch, being a natural polymer, is often used in food applications where hydrogen bonding is its main driving force. However, hydrogen bonding is significantly weaker than typical covalent bonding in chemical reactions. Starch, when used as an adhesive, performs poorly in terms of water resistance and bonding strength. Although modified starch has been developed to increase covalent bonding through chemical reactions, its water resistance and bonding strength still do not meet commercial requirements.

### SUMMARY OF THE INVENTION

According to the shortcomings of the prior art, the present invention primarily provides a water-based adhesive applied to wood or bamboo, incorporating natural and renewable materials. This effectively reduces reliance on petrochemical products and enhances the sustainability of related industries.

It is an object of the present invention is to provide a provide a water-based adhesive that can be applied to wood or bamboo. Its raw material is derived from natural latex, combined with environmentally friendly and non-toxic water-soluble polymers. It is further mixed with suitable curing agents, such as isocyanates or quaternary ammonium salt polymers, to provide excellent water resistance, adhesion strength, and mechanical strength for wood and bamboo.

It is an object of the present invention is to provide an adhesive that can be applied to wood and bamboo. It consists of a main agent and a curing agent. The main agent includes water-soluble polymers, synthetic rubber latex, and natural latex. The curing agent is an isocyanate compound or its polymer, or a solution of quaternary ammonium salt polymer.

According to above objects, the present invention provides a water-based adhesive applied to wood and bamboo includes a main agent composed of water-soluble polymer, synthetic rubber latex and natural latex and a curing agent selected from isocyanate or quaternary ammonium salt polymer, wherein, the weight ratio of the main agent to the curing agent is between 200:1 and 1:1; the water-soluble polymer is polyvinyl alcohol and is about 2-30 weight percent of the total solids of the main agent; the synthetic rubber latex is selected from the group consisting of styrene butadiene rubber latex and styrene butadiene rubber latex containing carboxylic acid functional groups and is about 2-60 weight percent of the total solids of the main agent; and the natural latex is about 5-90 weight percent of the total solids of the main agent.

In a preferred embodiment of the present invention, the weight ratio of the main agent to the curing agent is between 100:1 and 10:3.

In a preferred embodiment of the present invention, the water-soluble polymer is about 3-25 weight percent of the total solids of the main agent.

In a preferred embodiment of the present invention, the water-soluble polymer is about 5-25 weight percent of the total solids of the main agent.

In a preferred embodiment of the present invention, the water-soluble polymer is about 10-25 weight percent of the total solids of the main agent.

In a preferred embodiment of the present invention, the hydrolysis mol % of the water-soluble polymer in the main agent between 70% and 99.8%.

In a preferred embodiment of the present invention, the hydrolysis mol % of the water-soluble polymer in the main agent between 80% and 99.8%.

In a preferred embodiment of the present invention, the hydrolysis mol % of the water-soluble polymer in the main agent between 85% and 99.5%.

In a preferred embodiment of the present invention, the synthetic rubber latex is about 3-55 weight percent of the total solids of the main agent.

In a preferred embodiment of the present invention, the synthetic rubber latex is about 3-40 weight percent of the total solids of the main agent.

In a preferred embodiment of the present invention, the synthetic rubber latex is about 3-30 weight percent of the total solids of the main agent.

In a preferred embodiment of the present invention, the natural latex is about 5-85 weight percent of the total solids of the main agent.

In a preferred embodiment of the present invention, the natural latex is about 5-75 weight percent of the total solids of the main agent.

In a preferred embodiment of the present invention, the natural latex is about 10-60 weight percent of the total solids of the main agent.

In a preferred embodiment of the present invention, the natural latex is obtained from plants. The natural latex includes epoxidized natural latex or deproteinized natural latex.

In a preferred embodiment of the present invention, the isocyanate includes one or more types of isocyanates, and the isocyanate is a compound or its polymer containing isocyanate functional groups.

In a preferred embodiment of the present invention, the quaternary ammonium salt polymer includes one or more types of quaternary ammonium salt polymers, and the quaternary ammonium salt polymer is polyaminoamide-epichlorohydrin resin (PAE).

In a preferred embodiment of the present invention, it further includes inorganic or organic fillers, wherein the inorganic fillers are selected from the groups consisting of calcium carbonate, magnesium carbonate, talcum powder, barium sulfate, kaolin, titanium dioxide, silicon oxide, aluminum oxide and glass fiber; and the organic filler is selected from the groups consisting of starch, lignin, tannin, cellulose, sugar and wood powder.

In a preferred embodiment of the present invention, the additives such as defoamers, thickeners, thixotropic agents, antioxidants, dispersants, and flame retardants are further included.

### DETAILED DESCRIPTION OF THE PREFERRED EMBODIMENT

In one embodiment, the present invention provides a water-based adhesive applied to wood and bamboo includes a main agent composed of water-soluble polymer, synthetic rubber latex and natural latex and a curing agent selected from isocyanate or quaternary ammonium salt polymer, wherein, the weight ratio of the main agent to the curing agent is between 200:1 and 1:1; the water-soluble polymer is polyvinyl alcohol and is about 2-30 weight percent of the total solids of the main agent; the synthetic rubber latex is selected from the group consisting of styrene butadiene rubber latex and styrene butadiene rubber latex containing carboxylic acid functional groups and is about 2-60 weight percent of the total solids of the main agent; and the natural latex is about 5-90 weight percent of the total solids of the main agent. In one embodiment, the weight ratio of the main agent to the curing agent may range from 100:1 to 10:3.

The bio-based natural latex used in this invention is derived from plants. The chemical structure of natural latex primarily consists of a polymer composed of isoprene units and is dispersed in water in a latex state. The natural latex used in this invention does not require further modification through artificial chemical methods and can be used directly. It exhibits excellent hydrophobicity, and when water is removed, it forms a highly water-resistant polymeric rubber film. When applied as an adhesive, it significantly enhances the water resistance of the bonded material. The disadvantage of natural latex is its poor stability. In one embodiment, ammonia water, potassium hydroxide, or chelating agents can be added as stabilizers. In another embodiment, an ammonia water in a weight percentage of 0.1-1 wt % can be added to the natural latex aqueous solution as a stabilizer and antibacterial agent.

In the main agent of the present invention, if the proportion of natural latex is too low, the significance of adding bio-based materials to enhance environmental sustainability is lost. On the other hand, if too much natural latex is added, it is prone to skinning due to slight evaporation of water, making it difficult to apply and coat. In one embodiment, the natural latex accounts for 5-85 weight percentage of the total solid content in the main agent. In another embodiment, the natural latex accounts for 5-75 weight percentage of the total solid content in the main agent. In another embodiment, the natural latex accounts for 10-60 weight percentage of the total solid content in the main agent.

In one embodiment, the natural latex of the present invention includes epoxidized natural latex or deproteinized natural latex. Epoxidized natural latex is obtained by chemically reacting the double bonds in the polymer chain to form epoxy functional groups. This enhances reactivity, increases crosslinking strength, and improves temperature resistance, water resistance, and adhesive mechanical strength. Deproteinized natural latex involves the removal of protein components from the latex, reducing the chances of mold and decay.

The water-soluble polymer in the main agent of the present invention is polyvinyl alcohol (PVA). The addition of water-soluble polymers enhances the reaction between the main agent and the curing agent, improving adhesion and water resistance. In one embodiment, the hydrolysis mol % of the water-soluble polymer in the main agent is between 80% and 99.8%. In another embodiment, the hydrolysis mol % of the water-soluble polymer in the main agent is between 85% and 99.5%. In this invention, if the hydrolysis degree is too low, reactivity decreases, resulting in a decrease in adhesion strength. In one embodiment, the water-soluble polymer accounts for 3-25 weight percentage of the total solid content in the main composition. In another embodiment, the water-soluble polymer is about 5-25 weight percentage of the total solid content in the main agent. In another embodiment, the water-soluble polymer is about 10-25 weight percentage of the total solid content in the main agent.

The synthetic rubber latex in the main agent of the present invention also enhances the reaction between the main agent and the curing agent, improving adhesion and water resistance. In one embodiment, the synthetic rubber latex of the present invention is about 3-55 weight percentage of the total solid content in the main agent. In another embodiment, the synthetic rubber latex ais about 3-40 weight percentage of the total solid content in the main agent. In another embodiment, the synthetic rubber latex is about 3-30 weight percentage of the total solid content in the main agent.

The curing agent in the present invention primarily facilitates the crosslinking reaction with the main composition. In one embodiment, the isocyanate includes one or more isocyanates, which are compounds or polymers containing isocyanate functional groups. In one embodiment, the isocyanate can be diphenylmethane diisocyanate (MDI), including its three isomers: 2,2′-MDI, 2,4′-MDI, and 4,4′-MDI, as well as their oligomers (crude MDI or polymeric MDI). In one embodiment, the isocyanate can be tolylene-2,4- and tolylene-2,6-diisocyanate (TDI) and their isomers. In one embodiment, the isocyanate can be 4,4′-diisocyanato-dicyclohexylmethane (H12MDI) and its isomers. In another embodiment, the isocyanate can be hexamethylene diisocyanate (HDI) and its isomers. In one embodiment, the isocyanate can be isophorone diisocyanate (IPDI). In one embodiment, the isocyanate can be o-Tolidine diisocyanate (TODI), which is 3,3′-dimethyl-4,4′-diphenylmethane diisocyanate.

The curing agent in the present invention can also be quaternary ammonium polymers, which may include one or more types of quaternary ammonium polymers. In one embodiment, the quaternary ammonium polymer can be a polyaminoamide epichlorohydrin (PAE) polymer, formed by the reaction of polyamidoamine with epichlorohydrin. This polymer has a structure represented by chemical formula 1, where n is an integer. In a preferred embodiment of the present invention, the quaternary ammonium polymer comprises one or more types of quaternary ammonium polymers, and the quaternary ammonium polymer is a polyaminoamide epichlorohydrin (PAE) resin. Its chemical formula is shown as formula (1):

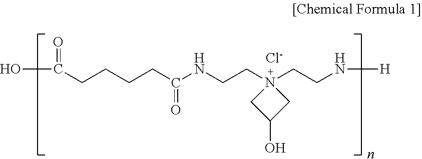

In one embodiment of the present invention, it further includes inorganic or organic fillers, wherein the inorganic fillers are selected from the groups consisting of calcium carbonate, magnesium carbonate, talcum powder, barium sulfate, kaolin, titanium dioxide, silicon oxide, aluminum oxide and glass fiber; and the organic filler is selected from the groups consisting of starch, lignin, tannin, cellulose, sugar and wood powder.

In one embodiment, in order to meet the process requirements, the main agent of the present invention may include additives such as defoamers, thickeners, rheology modifiers, antioxidants, dispersants, flame retardants, and other auxiliary agents. Alternatively, to meet additional specific requirements such as increasing the solid content of adhesives, improving opacity, reducing costs, etc., the main agent of the present invention may include inorganic or organic fillers. Inorganic fillers can include calcium carbonate, magnesium carbonate, talc, barium sulfate, kaolin, titanium dioxide, silica, alumina, or glass fibers. Organic fillers can include starch, lignin, tannin, cellulose, sugar, or wood powder.

The following examples and comparative examples are provided to further illustrate the present invention.

### Embodiment 1

A main agent of water-based adhesive was prepared by mixing 10 grams of polyvinyl alcohol (PVA) water solution (BP-05, 30 wt %, manufactured by Changchun Synthetic Resin) with 20 grams of styrene-butadiene rubber (SBR) resin (LBT04, specially formulated by Shenfeng Materials). After thorough mixing, 50 grams of natural latex (60 wt %, produced in Thailand) was added and stirred until a homogeneous mixture was obtained. Diphenylmethane diisocyanate (MDI) was used as the curing agent for the water-based adhesive. 10 grams of MDI was added to 80 grams of the main agent and mixed well before use. To evaluate the adhesive performance, wooden boards were bonded according to the method specified in SS-EN 205 (Adhesives-Wood adhesives for non-structural applications-Determination of tensile shear strength of lap joints). Mechanical tensile specimens were prepared as required by SS-EN 12765 (Classification of thermosetting wood adhesives for non-structural applications) with the C4 standard. The test results are shown in Table 1.

### Embodiment 2

A main agent of water-based adhesive was prepared by mixing 10 grams of polyvinyl alcohol (PVA) water solution (BP-05, 30 wt %, manufactured by Changchun Synthetic Resin) with 20 grams of styrene-butadiene rubber (SBR) resin (LBT04, specially formulated by Shenfeng Materials). After thorough mixing, 50 grams of natural latex (60 wt %, produced in Thailand) was added and stirred until a homogeneous mixture was obtained. Quaternary ammonium polymer (PAE, manufactured by Changchun Synthetic Resin) was used as the curing agent for the water-based adhesive. 10 grams of PAE was added to 80 grams of the main agent and mixed well before use. To evaluate the adhesive performance, wooden boards were bonded according to the method specified in SS-EN 205 (Adhesives-Wood adhesives for non-structural applications-Determination of tensile shear strength of lap joints). Mechanical tensile specimens were prepared as required by SS-EN 12765 (Classification of thermosetting wood adhesives for nonstructural applications) with the C4 standard. The test results are shown in Table 1.

### Embodiment 3

A main agent of water-based adhesive was prepared by mixing 50 grams of polyvinyl alcohol (PVA) water solution (BP-05, 30 wt %, manufactured by Changchun Synthetic Resin) with 20 grams of styrene-butadiene rubber (SBR) resin (LBT04, specially formulated by Shenfeng Materials). After thorough mixing, 10 grams of natural latex (60 wt %, produced in Thailand) and 20 grams of calcium carbonate were added and stirred until a homogeneous mixture was obtained. Diphenylmethane diisocyanate (MDI) was used as the curing agent for the water-based adhesive. 10 grams of MDI was added to 100 grams of the second component and mixed well before use. To evaluate the adhesive performance, wooden boards were bonded according to the method specified in SS-EN 205 (Adhesives-Wood adhesives for non-structural applications-Determination of tensile shear strength of lap joints). Mechanical tensile specimens were prepared as required by SS-EN 12765 (Classification of thermosetting wood adhesives for nonstructural applications) with the C4 standard. The test results are shown in Table 1.

### Embodiment 4

A main agent of water-based adhesive was prepared by mixing 20 grams of polyvinyl alcohol (PVA) water solution (BP-05, 30 wt %, main agent manufactured by Changchun Synthetic Resin) with 50 grams of styrene-butadiene rubber (SBR) resin (LBT04, main agent specially formulated by Shenfeng Materials). After thorough mixing, 10 grams of natural latex (60 wt %, main agent produced in Thailand) and 20 grams of calcium carbonate were added and stirred until a homogeneous mixture was obtained. Diphenylmethane diisocyanate (MDI) was used as the curing agent for the water-based adhesive. 10 grams of MDI was added to 100 grams of the main agent and mixed well before use. To evaluate the adhesive performance, wooden boards were bonded according to the method specified in SS-EN 205 (Adhesives-Wood adhesives for non-structural applications-Determination of tensile shear strength of lap joints). Mechanical tensile specimens were prepared as required by SS-EN 12765 (Classification of thermosetting wood adhesives for nonstructural applications) with the C4 standard. The test results are shown in Table 1.

### Comparative Example 1

A main agent of water-based adhesive was prepared by mixing 40 grams of styrene-butadiene rubber (SBR) resin (LBT04, main agent specially formulated by Shenfeng Materials) with 40 grams of natural latex (60 wt %, main agent produced in Thailand) and 20 grams of calcium carbonate. The mixture was thoroughly stirred until homogeneous to complete the main agent of the water-based adhesive. Diphenylmethane diisocyanate (MDI) was used as the curing agent for the water-based adhesive. 10 grams of MDI was added to 100 grams of the main agent and mixed well before use. To evaluate the adhesive performance, wooden boards were bonded according to the method specified in SS-EN 205 (Adhesives-Wood adhesives for non-structural applications-Determination of tensile shear strength of lap joints). Mechanical tensile specimens were prepared as required by SS-EN 12765 (Classification of thermosetting wood adhesives for nonstructural applications) with the C4 standard. The test results are shown in Table 1.

### Comparative Example 2

A main agent of water-based adhesive was prepared by mixing 40 grams of polyvinyl alcohol (PVA) aqueous solution (BP-05, 30 wt %, main agent with Changchun synthetic resin), 40 grams of natural latex (60 wt %, main agent produced in Thailand), and 20 grams of calcium carbonate. The mixture was thoroughly stirred until homogeneous to complete the main agent of the water-based adhesive. Diphenylmethane diisocyanate (MDI) was used as the curing agent for the water-based adhesive. 10 grams of MDI was added to 100 grams of the main agent and mixed well before use. To evaluate the adhesive performance, wooden boards were bonded according to the method specified in SS-EN 205 (Adhesives-Wood adhesives for non-structural applications-Determination of tensile shear strength of lap joints). Mechanical tensile specimens were prepared as required by SS-EN 12765 (Classification of thermosetting wood adhesives for nonstructural applications) with the C4 standard. The test results are shown in Table 1.

The adhesive formulations and the results of the bond strength tests for the above-mentioned embodiments 1˜4 and comparative examples 1-2 are presented in Table 1.

TABLE 1

| | Embodiment | Embodiment | Embodiment | Embodiment | Comparative | Comparative |
|---|---|---|---|---|---|---|
| | 1 | 2 | 3 | 4 | Example 1 | Example 2 |
| PVA | 10 | 10 | 50 | 20 | — | 40 |
| SBR | 20 | 20 | 20 | 50 | 40 | — |
| Natural Latex | 50 | 50 | 10 | 10 | 40 | 40 |
| Calcium Carbonate | | | 20 | 20 | 20 | 20 |
| MDI | 10 | — | 10 | 10 | 10 | 10 |
| PAE | — | 10 | — | — | | |
| Test Conditions | Wood Bonding Strength (N/mm²) | | | | | |
| 1 (Dry conditions) ≥ 10 | 12.1 | 11.3 | 18.9 | 18.2 | 10.2 | 10.5 |
| 2 (Wet conditions) ≥ 7 | 11.6 | 10.6 | 15.3 | 14.8 | 2.8 | 4.9 |
| 3 (Wet conditions) ≥ 4 | 5.4 | 4.7 | 8.4 | 7.3 | 0.2 | 0.9 |
| C4 | PASS | PASS | PASS | PASS | Fail | Fail |

Condition 1: Placed at room temperature and atmospheric pressure for 7 days (temperature: 20 ± 2° C., relative humidity: 65 ± 5%).
Condition 2: Placed at room temperature and atmospheric pressure for 7 days (temperature: 20 ± 2° C., relative humidity: 65 ± 5%), followed by immersion in water at 20 ± 5° C. for 1 day.
Condition 3: Placed at room temperature and atmospheric pressure for 7 days (temperature: 20 ± 2° C., relative humidity: 65 ± 5%), followed by immersion in boiling water for 3 hours and then immersion in water at 20 ± 5° C. for 2 hours.

Referring to Embodiment 1 and Embodiment 2, the wood panels bonded with the water-based adhesive formulated in Embodiment 1 can meet the most stringent C4 standard. On the other hand, Embodiment 2, which utilizes PAE as the curing agent, produces slightly lower bond strength compared to Embodiment 1, where MDI is used as the curing agent. However, the wood panels bonded with the adhesive formulation of Embodiment 2 still meet the requirements of the C4 standard.

Referring to Embodiment 3, the formulation of Embodiment 3 increases the amount of polyvinyl alcohol and includes the addition of calcium carbonate to enhance the overall solid content of the water-based adhesive. As a result, the bond strength of the wood panels bonded with the adhesive formulation of Embodiment 3 remains unaffected and can still meet the requirements of the C4 standard.

Please refer to Embodiment 4, where the formulation increases the proportion of styrene-butadiene rubber (SBR) and includes the addition of calcium carbonate to enhance the overall solid content of the water-based adhesive. As a result, the bond strength of the wood panels bonded with the adhesive formulation of Embodiment 4 remains unaffected and can still meet the requirements of the C4 standard.

Please refer to Comparative Example 1, where a water-based adhesive is produced without the addition of polyvinyl alcohol. The wood panels bonded with the adhesive formulation of Comparative Example 1 exhibit a significant decrease in bond strength under humid conditions and fail to meet the requirements of the C4 standard.

Please refer to Comparative Example 2, where a water-based adhesive is produced without the addition of styrene-butadiene rubber. The wood panels bonded with the adhesive formulation of Comparative Example 2 exhibit a significant decrease in bond strength under humid conditions and fail to meet the requirements of the C4 standard.

In summary, the water-based adhesive of the present invention offers several advantages. Firstly, it eliminates the use of formaldehyde and incorporates natural renewable materials, reducing reliance on petrochemical products. The bio-based material used in this invention is natural latex, which is combined with environmentally friendly non-toxic water-soluble polymers and a rubber latex, and further mixed with an appropriate curing agent. The water-based adhesive of the present invention provides excellent water resistance, bond strength, and mechanical strength for wood and bamboo materials.

The above description is merely exemplary of the preferred embodiments of the present invention and should not be construed as limiting the scope of the invention. Any modifications, equivalents, substitutions, or improvements made within the spirit and principles of the present invention should be encompassed within the scope of protection of the invention.

What is claimed is:

1. A water-based adhesive applied to wood and bamboo includes a main agent composed of water-soluble polymer, synthetic rubber latex and natural latex and a curing agent selected from isocyanate or quaternary ammonium salt polymer, wherein the weight ratio of the main agent to the curing agent is between 200:1 and 1:1; the water-soluble polymer is polyvinyl alcohol and is about 2-30 weight percent of the total solids of the main agent; the synthetic rubber latex is selected from the group consisting of styrene butadiene rubber latex and styrene butadiene rubber latex containing carboxylic acid functional groups and is about 2-60 weight percent of the total solids of the main agent; and the natural latex is about 5-90 weight percent of the total solids of the main agent.

2. The water-based adhesive according to claim 1, wherein the weight ratio of the main agent to the curing agent is between 100:1 and 10:3.

3. The water-based adhesive according to claim 1, wherein the water-soluble polymer is about 3-25 weight percent of the total solids of the main agent.

4. The water-based adhesive according to claim 1, wherein the hydrolysis mol % of the water-soluble polymer in the main agent between 70% and 99.8%.

5. The water-based adhesive according to claim 1, wherein the synthetic rubber latex is about 3-55 weight percent of the total solids of the main agent.

6. The water-based adhesive according to claim 1, wherein the natural latex is about 5-85 weight percent of the total solids of the main agent.

7. The water-based adhesive according to claim 1, wherein the natural latex is about 5-75 weight percent of the total solids of the main agent.

8. The water-based adhesive according to claim 1, wherein the natural latex is selected from the groups consisting of epoxidized natural latex and deproteinized natural latex.

9. The water-based adhesive according to claim 1, wherein the isocyanate includes one or more types of isocyanates, and the isocyanate is a compound or its polymer containing isocyanate functional groups.

10. The water-based adhesive according to claim 1, wherein the quaternary ammonium salt polymer includes one or more types of quaternary ammonium salt polymers, and the quaternary ammonium salt polymer is polyaminoamide-epichlorohydrin resin (PAE).

11. The water-based adhesive according to claim 1, further includes inorganic or organic fillers, wherein the inorganic fillers are selected from the groups consisting of calcium carbonate, magnesium carbonate, talcum powder, barium sulfate, kaolin, titanium dioxide, silicon oxide, aluminum oxide and glass fiber; and the organic filler is selected from the groups consisting of starch, lignin, tannin, cellulose, sugar and wood powder.

12. The water-based adhesive according to claim 1, further includes the additives such as defoamers, thickeners, thixotropic agents, antioxidants, dispersants, and flame retardants.
